(19) United States
(12) Patent Application Publication
(10) Pub. No.: US 2025/0381749 A1
(43) Pub. Date: Dec. 18, 2025

(54) HEAT PRESS BONDING APPARATUS

(71) Applicant: Innostar Service Inc., Taichung City (TW)

(72) Inventor: Chih-Meng WU, Taichung City (TW)

(21) Appl. No.: 18/911,036

(22) Filed: Oct. 9, 2024

(30) Foreign Application Priority Data
Jun. 18, 2024 (TW) 113206385

(51) Int. Cl. B30B 15/14; B30B 15/00

(52) U.S. Cl. CPC B30B 15/148; B30B 15/0094

(57) ABSTRACT

A heat press bonding apparatus including: a working chamber having a non-oxidizing atmosphere; a heat press device located in the working chamber and having a water cooling mechanism for performing a heat press operation on a workpiece assembly to form a finished product; a pair of two-way water-cooling conveyors located on two opposite sides of the working chamber for feeding the workpiece assembly into the heat press device and receiving and cooling down the finished product from the heat press device; and a control module electrically coupled with the heat press device for controlling temperatures and pressures of the heat press operation. Accordingly, the invention can optimize the effect of heat press bonding, enhance the production efficiency, and prevent operators from getting burned.

### BACKGROUND OF THE INVENTION

### Field of the Invention

The invention relates to a heat press bonding apparatus, in particular to a heat press bonding apparatus capable of optimizing the heat press bonding effect.

### Description of the Related Art

Heat press bonding technology is about joining two workpieces into a module by heat pressing the two workpieces, where the two workpieces may be individually an electronic component, a circuit board, a metal substrate, or a wafer.

However, the existing heat press bonding technology can cause problems to the products if the temperature is too high or the pressure is too high. For 3D (three-dimensional) packaging, if higher pressures than needed and/or higher temperatures than needed are applied to the two workpieces during the bonding process, it can significantly increase the thermal stress inside the bonded module, thereby reducing the performance and usage life of the module.

To solve the above mentioned problems, a novel heat press bonding apparatus is needed in the field.

### SUMMARY OF THE INVENTION

The main objective of the invention is to provide a heat press bonding apparatus, which can precisely control the compression amount of a workpiece assembly by adjusting the working temperatures and working pressures during a heat press operation, so that the heat press operation can be carried out according to a compression plan to optimize the bonding effect.

Another objective of the invention is to provide a heat press bonding apparatus, which can provide a heat insulation effect on the outer surface of a heat press device by utilizing a water cooling device, so as to prevent the other devices of the heat press bonding apparatus from being exposed to high temperatures, and at the same time, protect operators from getting burned.

Another objective of the invention is to provide a heat press bonding apparatus, which can optimize the heat press bonding effect of a workpiece assembly by forming a non-oxidizing atmosphere in a working chamber.

Still another objective of the invention is to provide a heat press bonding apparatus having a two-way water-cooling conveyor on two opposite sides, which can feed a workpiece assembly into a heat press device on either side, and receive and cool down a finished product from the heat press device on the other side, thereby improving production efficiency.

To achieve the above objectives, a heat press bonding apparatus is proposed, which includes:
a working chamber having a non-oxidizing atmosphere;
a heat press device located in the working chamber and having an upper heat press module and a lower heat press module, the upper heat press module and the lower heat press module both having a water cooling device and a heating block engaged with the water cooling device, and the heating block of the upper heat press module being opposite to the heating block of the lower heat press module for performing a heat press operation on a workpiece assembly to form a finished product;
a first two-way water-cooling conveyor located on one side of the working chamber for feeding the workpiece assembly into the heat press device or receiving and cooling down the finished product from the heat press device;
a second two-way water-cooling conveyor located on an opposite side of the working chamber for feeding the workpiece group into the heat press device or receiving and cooling down the finished product from the heat press device; and
a control module electrically coupled with the heat press device for controlling temperatures of the heating block of the upper heat press module and the heating block of the lower heat press module, and for controlling a pressure between the heating block of the upper heat press module and the heating block of the lower heat press module.

In one embodiment, the heat press device has a pressure detector located in the upper heat press module or the lower heat press module, and electrically coupled to the control module for providing pressure sensing values to the control module.

In one embodiment, the pressure detector is a load cell.

In one embodiment, the heat press device has a temperature detector located in the upper heat press module or the lower heat press module, and electrically coupled to the control module for providing temperature sensing values to the control module.

In one embodiment, the control module adjusts the heat press operation according to the temperature sensing values and the pressure sensing values to make the heat press operation carried out according to a compression plan to result in a required compression amount of the workpiece assembly.

In one embodiment, the heat press bonding apparatus further has a gas supply device for evacuating the working chamber and then supplying a gas to the working chamber to form the non-oxidizing atmosphere.

In possible embodiments, the gas can be nitrogen or hydrogen.

In one embodiment, the workpiece assembly includes a first workpiece and a second workpiece, and the first workpiece and the second workpiece can be individually an electronic component, a circuit board, a metal substrate, or a wafer. To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a schematic diagram of one embodiment of the heat press bonding apparatus of the invention;

FIG. 2 is a schematic diagram of one embodiment of the heat press device of the heat press bonding apparatus of FIG. 1;

FIGS. 3a-3d illustrate an operation of the heat press bonding apparatus of FIG. 1; and

FIGS. 4a-4d illustrate another operation of the heat press bonding apparatus of FIG. 1.

### DETAILED DESCRIPTION OF THE PREFERRED EMBODIMENTS

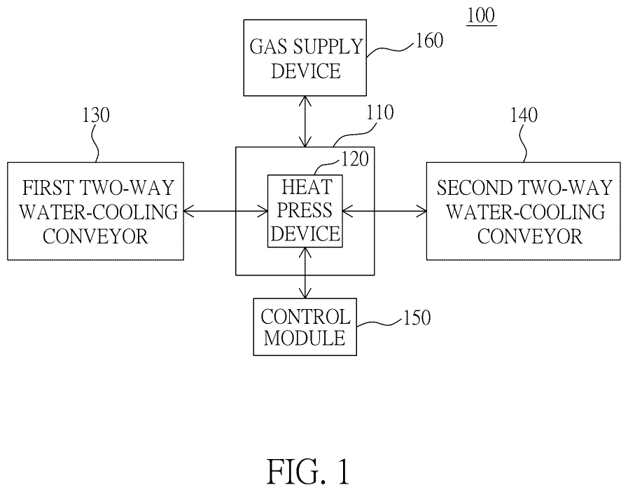

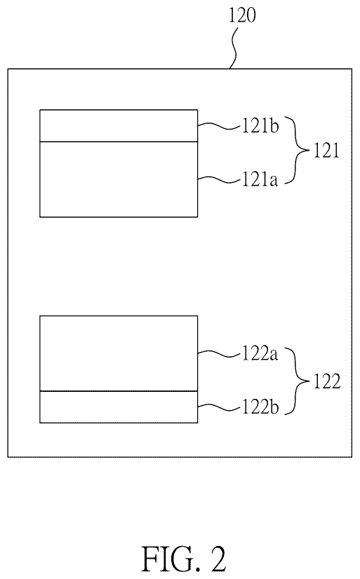

Please refer to FIGS. 1 and 2, where FIG. 1 is a schematic diagram of one embodiment of the heat press bonding apparatus of the invention, and FIG. 2 is a schematic diagram of one embodiment of the heat press device of the heat press bonding apparatus of FIG. 1.

As illustrated in FIGS. 1 and 2, a heat press bonding apparatus 100 has a working chamber 110, a heat press device 120, a first two-way water-cooling conveyor 130, a second two-way water-cooling conveyor 140, a control module 150, and a gas supply device 160.

The working chamber 110 has a non-oxidizing atmosphere.

The heat press device 120 is located in the working chamber 110 and has an upper heat press module 121 and a lower heat press module 122, where the upper heat press module 121 has a heating block 121a and a water-cooling device 121b engaged with the heating block 121a; the lower heat press module 122 has a heating block 122a and a water-cooling device 122b engaged with the heating block 122a; and the heating block 121a of the upper heat press module 121 is opposite to the heating block 122a of the lower heat press module 122 for performing a heat press operation on a workpiece assembly to form a finished product.

Besides, the heat press device 120 has a pressure detector (not shown in the figure), which can be located in the upper heat press module 121 or the lower heat press module 122 and is electrically coupled to the control module 150 to provide pressure sensing values to the control module 150. In addition, the pressure detector can be a load cell, which generates a voltage signal proportional to a vertical force when the load cell is subjected to the vertical force, and outputs the voltage signal to the control module 150.

In addition, the heat press device 120 has a temperature detector (not shown in the figure), which may be located in the upper heat press module 121 or the lower heat press module 122, and is electrically coupled to the control module 150 to provide temperature sensing values to the control module 150. As the temperature detector is a known device, the principle of which will not be further addressed here.

The first two-way water-cooling conveyor 130 is located on one side of the working chamber 110 for feeding the workpiece assembly into the heat press device 120, or receiving and cooling down the finished product from the heat press device 120.

The second two-way water-cooling conveyor 140 is located on the other side of the working chamber 110 for feeding the workpiece assembly into the heat press device 120, or receiving and cooling down the finished product from the heat press device 120.

The control module 150 is electrically coupled with the heat press device 120 for controlling the temperature of the heating block 121a of the upper heat press module 121, the temperature of the heating block 122a of the lower heat press module 122, and the pressure between the heating block 121a of the upper heat press module 121 and the heating block 122a of the lower heat press module 122. To be specific, the control module 150 performs the heat press operation according to a predetermined compression plan having plural phases, each of the phases specifying a required temperature curve and a required pressure curve over a time period. That is, the control module 150 uses the temperature sensing values and the pressure sensing values as feedback variables to control the heat press device 120 to generate the required temperature curve and the required pressure curve for each of the phases, thereby resulting in a required compression amount of the workpiece assembly.

The gas supply device 160 is used to evacuate the working chamber 110 and then supply a gas to the working chamber 110 to form the non-oxidizing atmosphere, where the gas can be nitrogen or hydrogen.

Besides, the workpiece assembly includes a first workpiece and a second workpiece, and the first workpiece and the second workpiece can be individually an electronic component, a circuit board, a metal substrate, or a wafer.

When in operation, the workpiece assembly can be fed from the first two-way water-cooling conveyor 130 into the heat press device 120, and the second two-way water-cooling conveyor 140 conveys and cools down the finished product received from the heat press device 120; or be fed from the second two-way water-cooling conveyor 140 into the heat press device 120, and the first two-way water-cooling conveyor 130 conveys and cools down the finished product received from the heat press device 120.

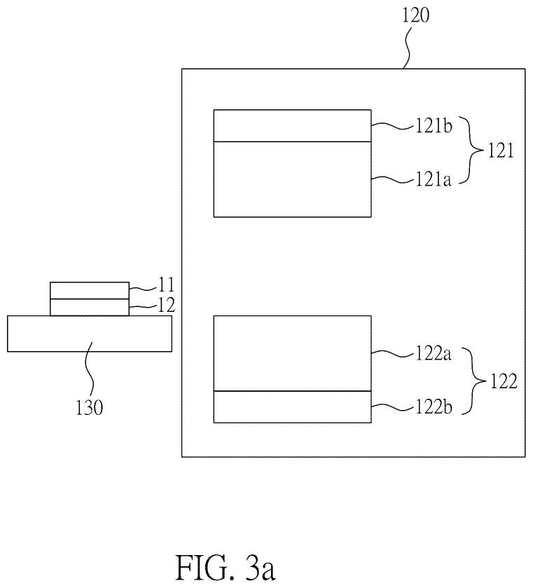

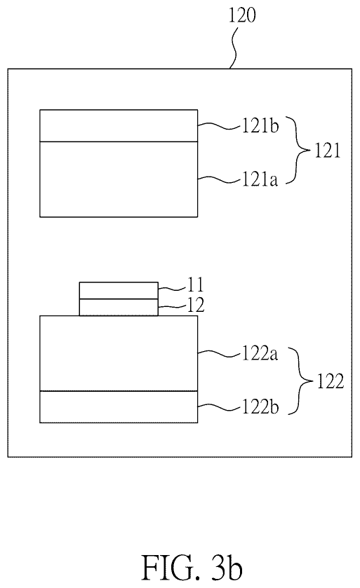

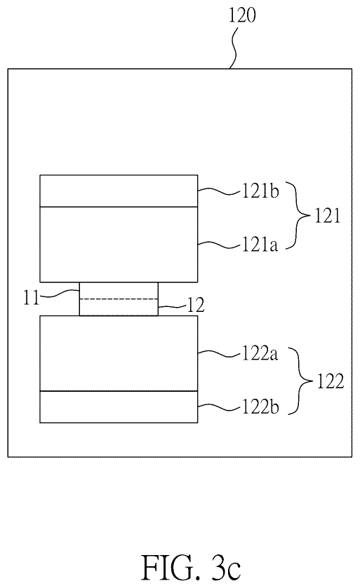

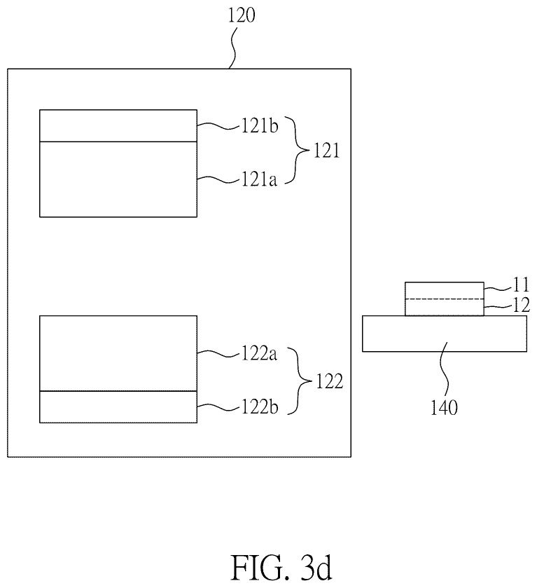

Please refer to FIGS. 3a-3d, which illustrate an operation of the heat press bonding apparatus of FIG. 1. As shown in FIG. 3a, a workpiece assembly (including a first workpiece 11 and a second workpiece 12) to be processed is first placed on the first two-way water-cooling conveyor 130; subsequently, as shown in FIG. 3b, the workpiece assembly is fed into the heat press device 120 to undergo a heat press operation; then, as shown in FIG. 3c, the first workpiece 11 and the second workpiece 12 are bonded into a module in the heat press device 120; and finally, as shown in FIG. 3d, the module is sent out of heat press device 120 and is conveyed and cooled down on the second two-way water-cooling conveyor 140.

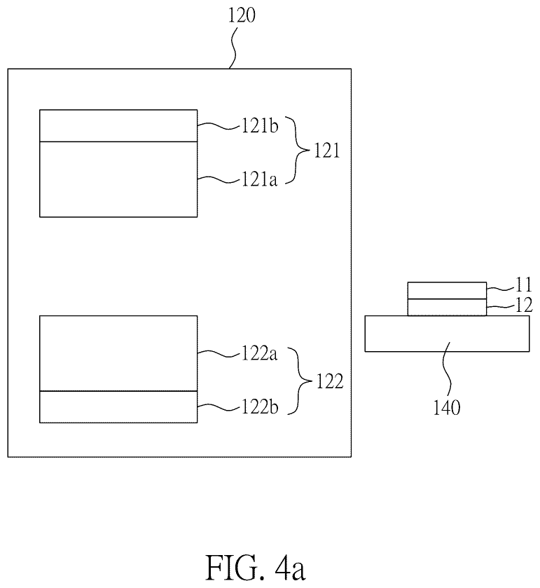

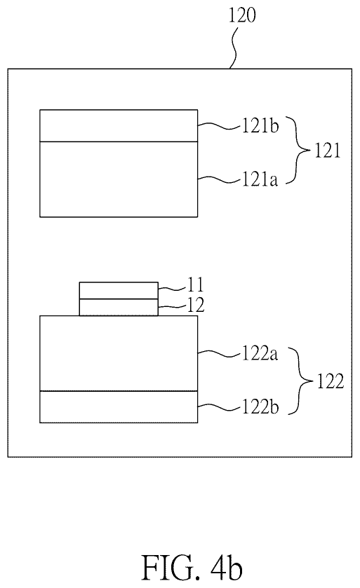

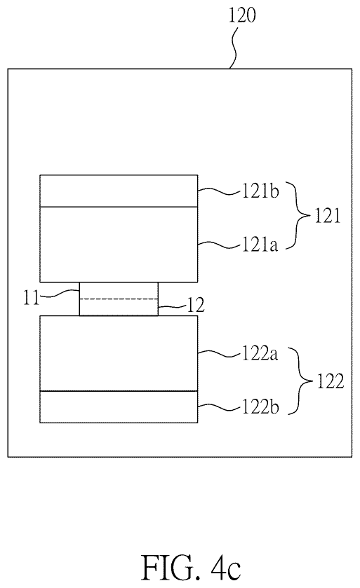

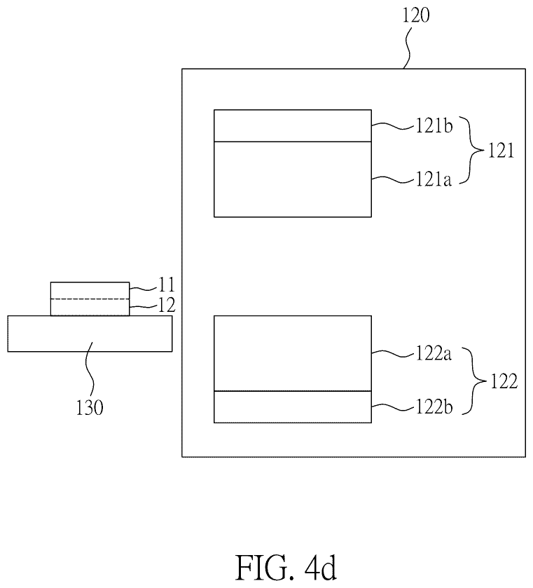

Please refer to FIGS. 4a-4d, which illustrate another operation of the heat press bonding apparatus of FIG. 1. As shown in FIG. 4a, a workpiece assembly (including a first workpiece 11 and a second workpiece 12) to be processed is first placed on the second two-way water-cooling conveyor 140; subsequently, as shown in FIG. 4b, the workpiece assembly is fed into the heat press device 120 to undergo a heat press operation; then, as shown in FIG. 4c, the first workpiece 11 and the second workpiece 12 are bonded into a module in the heat press device 120; and finally, as shown in FIG. 4d, the module is sent out of heat press device 120 and is conveyed and cooled down on the first two-way water-cooling conveyor 130.

As can be seen from the specification above, the invention discloses a heat press bonding apparatus, which includes a working chamber having a non-oxidizing atmosphere; a heat press device located in the working chamber and having an upper heat press module and a lower heat press module, the upper heat press module and the lower heat press module both having a water cooling device and a heating block engaged with the water cooling device, and the heating block of the upper heat press module being opposite to the heating block of the lower heat press module for performing a heat press operation on a workpiece assembly to form a finished product; a first two-way water-cooling conveyor located on one side of the working chamber for feeding the workpiece assembly into the heat press device or receiving and cooling down the finished product from the heat press device; a second two-way water-cooling conveyor located on an opposite side of the working chamber for feeding the workpiece group into the heat press device or receiving and cooling down the finished product from the heat press device; and a control module electrically coupled with the heat press device for controlling temperatures of the heating block of the upper heat press module and the heating block of the lower heat press module, and for controlling a pressure between the heating block of the upper heat press module and the heating block of the lower heat press module.

In addition, the heat press device has a pressure detector located in the upper heat press module or the lower heat press module, and electrically coupled to the control module for providing pressure sensing values to the control module, where the pressure detector can be a load cell.

In addition, the heat press device has a temperature detector located in the upper heat press module or the lower heat press module, and electrically coupled to the control module for providing temperature sensing values to the control module.

It is worth mentioning that the control module can adjust the heat press operation according to the temperature sensing values and the pressure sensing values to make the heat press operation carried out according to a compression plan to result in a required compression amount of the workpiece assembly.

In addition, the heat press bonding apparatus can further include a gas supply device for evacuating the working chamber and then supplying a gas to the working chamber to form the non-oxidizing atmosphere, where the gas can be nitrogen or hydrogen.

In addition, the workpiece assembly includes a first workpiece and a second workpiece, and the first workpiece and the second workpiece can be individually an electronic component, a circuit board, a metal substrate, or a wafer.

With the designs mentioned above, the invention has the following advantages:
1. The heat press bonding apparatus of the invention can precisely control the compression amount of a workpiece assembly by adjusting the temperatures and pressures during a heat press operation, so that the heat press operation can be carried out according to a compression plan to optimize the bonding effect;
2. The heat press bonding apparatus of the invention can provide a heat insulation effect on the outer surface of a heat press device by utilizing a water cooling device, so as to prevent the other devices of the heat press bonding apparatus from being exposed to high temperatures, and at the same time, protect operators from getting burned;
3. The heat press bonding apparatus of the invention can optimize the heat press bonding effect of a workpiece assembly by forming a non-oxidizing atmosphere in a working chamber; and
4. The heat press bonding apparatus of the invention, by utilizing a two-way water-cooling conveyor on two opposite sides of the heat press device, can feed a workpiece assembly into the heat press device on either side, and receive and cool down a finished product from the heat press device on the other side, thereby improving production efficiency.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A heat press bonding apparatus comprising:
a working chamber having a non-oxidizing atmosphere;
a heat press device located in the working chamber and having an upper heat press module and a lower heat press module, the upper heat press module and the lower heat press module both having a water cooling device and a heating block engaged with the water cooling device, and the heating block of the upper heat press module being opposite to the heating block of the lower heat press module for performing a heat press operation on a workpiece assembly to form a finished product;
a first two-way water-cooling conveyor located on one side of the working chamber for feeding the workpiece assembly into the heat press device or receiving and cooling down the finished product from the heat press device;
a second two-way water-cooling conveyor located on an opposite side of the working chamber for feeding the workpiece group into the heat press device or receiving and cooling down the finished product from the heat press device; and
a control module electrically coupled with the heat press device for controlling temperatures of the heating block of the upper heat press module and the heating block of the lower heat press module, and for controlling a pressure between the heating block of the upper heat press module and the heating block of the lower heat press module.

2. The heat press bonding apparatus as disclosed in claim 1, wherein the heat press device has a pressure detector located in the upper heat press module or the lower heat press module, and electrically coupled to the control module for providing pressure sensing values to the control module.

3. The heat press bonding apparatus as disclosed in claim 2, wherein the pressure detector is a load cell.

4. The heat press bonding apparatus as disclosed in claim 2, wherein the heat press device has a temperature detector located in the upper heat press module or the lower heat press module, and electrically coupled to the control module for providing temperature sensing values to the control module.

5. The heat press bonding apparatus as disclosed in claim 4, wherein the control module adjusts the heat press operation according to the temperature sensing values and the pressure sensing values to make the heat press operation carried out according to a compression plan to result in a required compression amount of the workpiece assembly.

6. The heat press bonding apparatus as disclosed in claim 1, wherein the heat press bonding apparatus further has a gas supply device for evacuating the working chamber and then supplying a gas to the working chamber to form the non-oxidizing atmosphere.

7. The heat press bonding apparatus as disclosed in claim 6, wherein the gas is nitrogen or hydrogen.

8. The heat press bonding apparatus as disclosed in claim 1, wherein the workpiece assembly includes a first workpiece and a second workpiece, and the first workpiece and the second workpiece are individually selected from a group consisting of an electronic component, a circuit board, a metal substrate, and a wafer.
